(19) United States
(12) Patent Application Publication
(10) Pub. No.: US 2016/0257568 A1
(43) Pub. Date: Sep. 8, 2016

(54) METHOD OF PREPARING ALUMINUM NITRIDE POWDER THROUGH ATMOSPHERE CONTROLLED CARBON-THERMAL REDUCTION

(71) Applicant: National Chung-Shan Institute of Science and Technology, Taoyuan County (TW)

(72) Inventors: Kuan-Ting Lai, Taoyuan County (TW); Chi-Shiung Hsi, Taoyuan County (TW); Min-Yu Yang, Taoyuan County (TW)

(21) Appl. No.: 14/962,741

(22) Filed: Dec. 8, 2015

(30) Foreign Application Priority Data
Mar. 6, 2015 (TW) 104107111

(51) Int. Cl. C01B 21/072

(52) U.S. Cl. CPC C01B 21/0726

(57) ABSTRACT

A method of preparing aluminum nitride powder through atmosphere controlled carbon-thermal reduction. It relates to a chemical dilution method to wrap the carbon material evenly around the surface of γ-aluminum oxide (gamma phase-aluminum oxide). The method includes the following processes of: material mixing, carbonization, carbon-thermal reduction, and de-carbonization. Wherein, γ-aluminum oxide and phenolic resin are mixed to form a solution, and after the solution is baked and dried into powder, it is carbonized under nitridation atmosphere in high temperature. Then, carbon-thermal reduction is performed in a temperature of 1400° C.˜1700° C. Finally, de-carbonized is performed in air. In the process of carbon-thermal reduction, ammonia gas and hydrogen gas are added to regulate the reacting atmosphere. Also, urea is added to increase the nitridation reaction of aluminum.

### BACKGROUND OF THE INVENTION

1. Field of the Invention

The present invention relates to a method of preparing aluminum nitride powder, and in particular to a method of preparing aluminum nitride powder through atmosphere controlled carbon-thermal reduction.

2. The Prior Arts

In general, the method of preparing aluminum nitride includes the following approaches: chemical vapor deposition (CVD), organic metal precursor method, direct nitridation method, carbon-thermal reduction method, and combustion synthesis method. In comparison, the carbon-thermal reduction method is most frequently utilized to prepare and produce aluminum nitride powder, for it is capable of producing aluminum nitride powder of high purity, fine grain, and being able to achieve stable functions. Conventionally, in the production process, carbon black is first mixed with aluminum oxide powder, then the mixture thus obtained is turned into aluminum nitride powder through carbon-thermal reduction. Usually, it is rather difficult to control the aluminum oxide powder and the carbon black to mix evenly, such that aluminum nitride powder can only be synthesized and obtained in a rather high temperature of over 1600° C. In addition, in this process, a higher mixing percentage of carbon black (the weight ratio of aluminum oxide to carbon black is 1:0.36) is required. As such, it requires longer time to complete the de-carbonization process.

Therefore, presently, the design and performance of the method of preparing aluminum nitride powder is not quite satisfactory, and it leaves much room for improvement.

### SUMMARY OF THE INVENTION

In view of the problems and drawbacks of the prior art, the present invention provides a method of preparing aluminum nitride powder through atmosphere controlled carbon-thermal reduction, to overcome the shortcomings of the prior art.

A major objective of the present invention is to provide a method of preparing aluminum nitride powder through atmosphere controlled carbon-thermal reduction, wherein, a chemical dilution method is used to wrap carbon material evenly around the surface of γ-aluminum oxide (gamma phase-aluminum oxide), then through the atmosphere controlled carbon-thermal reduction, the aluminum nitride powder can be prepared by using less amount of carbon, at lower temperature.

The method of preparing aluminum nitride powder through atmosphere controlled carbon-thermal reduction includes the following steps. Firstly, mix the γ-aluminum oxide (gamma phase-aluminum oxide) with phenolic resin evenly, at a weight ratio of 1:0.4˜0.8. Next, after they are mixed evenly, add in ethyl alcohol solution of 40%˜60%, to dissolve the phenolic resin, and to form evenly mixed solution. Then, put the solution in a bake oven, to bake and dry it into powder.

Subsequently, perform carbonization of the powder thus obtained in a temperature of 500° C.˜700° C., such that the phenolic resin is turned into carbon black, to form evenly plated layer on the surface of the aluminum oxide.

After carbonization, the powder is formed and gathered into conglomerates, then they go through a preliminary grinding process to be ground into powder particles of diameter less than 2 mm.

Afterwards, the grinded powder is put through a nitridation process, to form aluminum nitride powder. In the nitridation process, the carbonized powder is added urea, to perform nitridation reaction in a temperature of 1400° C.˜1700° C. The nitridation atmosphere can be formed of pure nitrogen gas, nitrogen gas plus ammonia gas, or nitrogen gas plus hydrogen gas.

Finally, the nitridated powder is performed de-carbonization in a temperature of 600° C.˜700° C., to produce and obtain the aluminum nitride powder as required.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a flowchart of a method of preparing aluminum nitride powder through atmosphere controlled carbon-thermal reduction according to an embodiment of the present invention;

FIG. 2 is an X-ray diffraction pattern of the aluminum nitride powder produced by the method of the present invention, in a nitridation atmosphere of 50% nitrogen gas and 50% ammonia gas through using carbonized powder and urea of a weight ration of 1:0.1;

FIG. 3 is an X-ray diffraction pattern of the aluminum nitride powder produced by the method of the present invention, in a nitridation atmosphere of 50% nitrogen gas and 50% ammonia gas, 50% nitrogen gas and 50% ammonia gas, or 95% nitrogen gas and 5% hydrogen gas, through using carbonized powder without adding any additives; and

FIG. 4 is an X-ray diffraction pattern of the aluminum nitride powder produced by the method of the present invention, in a nitridation atmosphere of 50% nitrogen gas and 50% ammonia gas, or a pure nitrogen gas, through using carbonized powder without adding any additives.

### DETAILED DESCRIPTION OF THE PREFERRED EMBODIMENT

The purpose, construction, features, functions and advantages of the present invention can be appreciated and understood more thoroughly through the following detailed description with reference to the attached drawings.

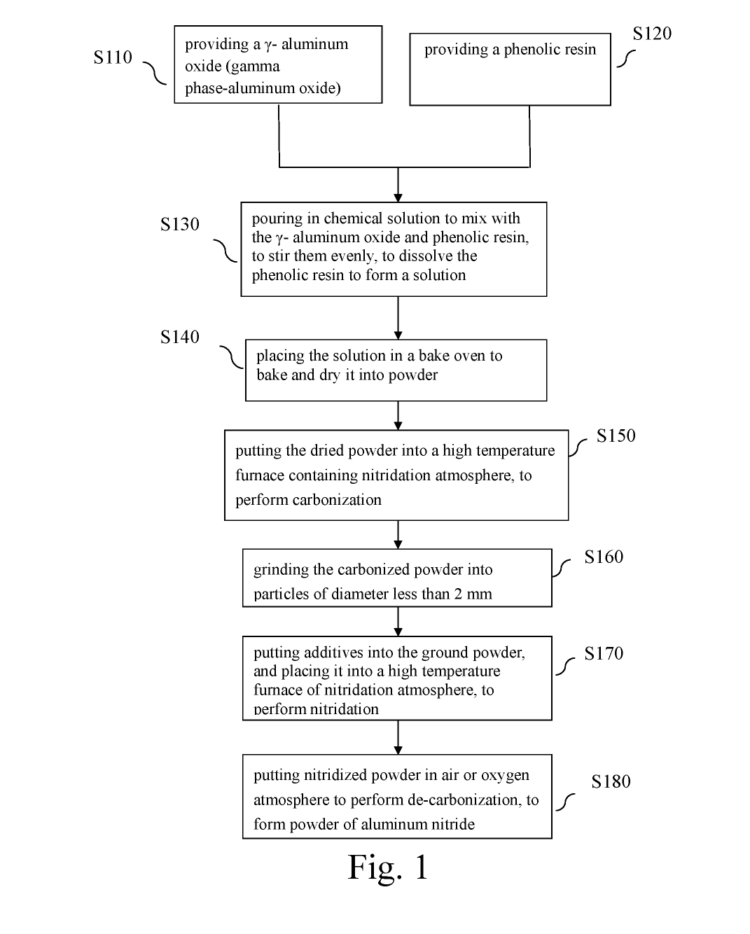

Refer to FIG. 1 for a flowchart of the steps of a method of preparing aluminum nitride powder through atmosphere controlled carbon-thermal reduction according to an embodiment of the present invention. As shown in FIG. 1, the method mentioned above including the following steps:

(1) Providing a γ-aluminum oxide (gamma phase-aluminum oxide), with the aluminum oxide particle size of 0.08˜2 mm (step 110).

(2) Providing a phenolic resin (step 120).

(3) Mixing the γ-aluminum oxide (gamma phase-aluminum oxide) with the phenolic resin, then pouring in chemical solution to stir them evenly together, to make the phenolic resin dissolve to form a solution. Wherein, the chemical solution is a water solution containing 40 wt %˜60 wt % of methyl alcohol, ethanol, isoprophyl alcohol, or butyl alcohol. While, weight ratio of γ-aluminum oxide and the phenolic resin 1:0.4˜0.8 (step 130).

(4) Placing the water solution in a bake oven, to bake and dry it into powder (step 140).

(5) Putting the dried powder into a high temperature furnace containing nitridation atmosphere in a temperature of 500° C.˜700° C., to perform carbonization, and to form into powder (step 150).

(6) Grinding the carbonized powder into particles of diameter less than 2 mm (step 160).

(7) Putting additives into the ground powder, and placing it into a high temperature furnace of nitridation atmosphere, to perform nitridation in a temperature of 1400° C.˜1800° C. Wherein, the weight ratio of the ground powder and that of the additive is 1:0.1˜1. The additive is urea or azide. The nitridation atmosphere is formed by pure nitrogen gas, a mixture of nitrogen gas and hydrogen gas, a mixture of nitrogen gas and ammonia gas, or pure ammonia gas (step 170).

(8) Placing the nitridized powder in air or an oxygen atmosphere to perform de-carbonization, to form powder of aluminum nitride. Wherein, the de-carbonization period is about 6˜12 hours (step 180).

In the following, three embodiments are used to explain the principles of the present invention. Wherein, X-ray diffraction patterns are used to verify the aluminum nitride powder produced by the method of the present invention.

### Embodiment 1

Mix 80 g of γ-aluminum oxide (gamma phase-aluminum oxide) with 32 g of the phenolic resin evenly, then add in 50 g of ethyl alcohol solution to form an evenly mixed solution. Then, the solution is placed into a bake oven in a temperature of 80° C. for an hour, to bake and form a solid object. Subsequently, the solid object is placed in a high temperature furnace at 700° C., to perform carbonization for 2 hours. Then, add urea into the carbonized powder (weight ratio of carbonized powder to urea is 1:0.1). Afterwards, perform carbon-thermal reduction in the high temperature furnace, under the condition of maintaining temperature at 1450° C. for 10 hours, maintaining temperature at 1500° C. for 10 hours, and maintaining temperature at 1600° C. for 7 hours, while increasing the temperature at 5° C./min.

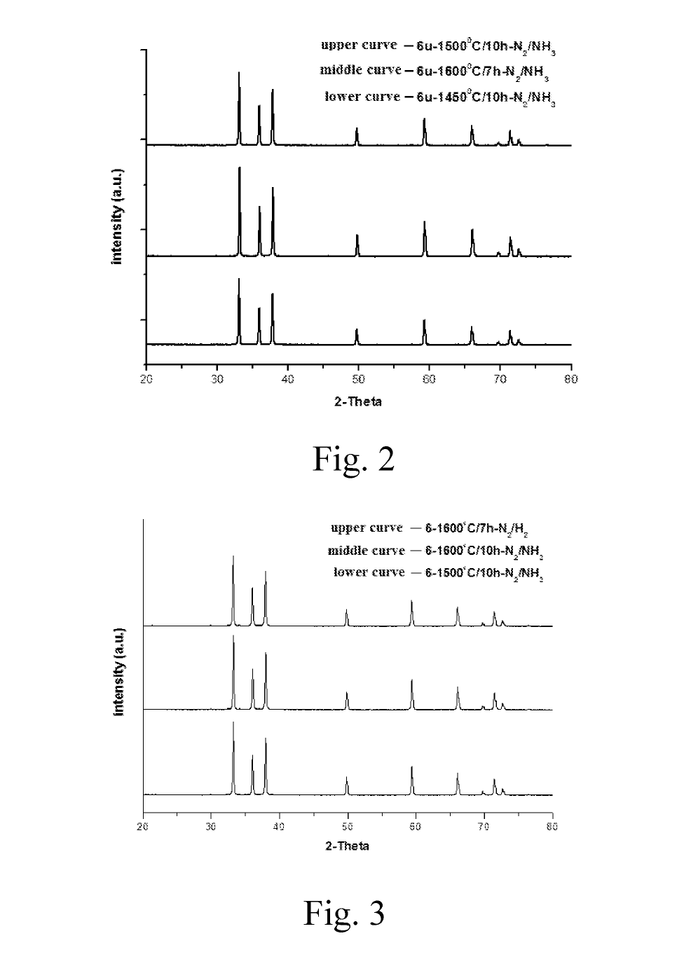

In this process, the atmosphere is formed by 50% nitrogen gas and 50% ammonia gas. After carbon-thermal reduction, the powder is placed into an air of 600° C. to perform de-carbonization, while keeping that temperature for 10 hours. The X-ray diffraction pattern of the de-carbonized powder is as shown in FIG. 2. From the diffraction patterns it is evident that, the powder is of a single pure phase aluminum nitride.

### Embodiment 2

Mix 80 g of γ-aluminum oxide (gamma phase-aluminum oxide) with 32 g of the phenolic resin evenly, then add in 50 g of ethyl alcohol solution to form an evenly mixed solution. Then, the solution is placed into a bake oven in a temperature of 80° C. for an hour, to bake and form a solid object. Subsequently, the solid object is placed in a high temperature furnace at 700° C., to perform carbonization for 2 hours. After carbonization, no urea is added to the carbonized powder. Then, perform carbon-thermal reduction in the high temperature furnace, under the condition of maintaining temperature at 1500° C. for 10 hours, maintaining temperature at 1600° C. for 10 hours, and maintaining temperature at 1600° C. for 7 hours, while increasing the temperature at 5° C./min.

In this process, the atmosphere is formed by 50% nitrogen gas and 50% ammonia gas, 95% nitrogen gas and 5% hydrogen gas. After carbon-thermal reduction, the powder is placed into an air of 600° C. to perform de-carbonization, while keeping that temperature for 10 hours. The X-ray diffraction pattern of the de-carbonized powder is as shown in FIG. 3. From the diffraction patterns it is evident that, the powder is of a single pure phase aluminum nitride.

### Embodiment 3

Mix 80 g of γ-aluminum oxide (gamma phase-aluminum oxide) with 32 g of the phenolic resin evenly, then add in 50 g of ethyl alcohol solution to form an evenly mixed solution. Then, the solution is placed into a bake oven in a temperature of 80° C. for an hour, to bake and form a solid object. Subsequently, the solid object is placed in a high temperature furnace at 700° C., to perform carbonization for 2 hours. After carbonization, no urea is added to the carbonized powder. Then, perform carbon-thermal reduction in the high temperature furnace, under the condition of maintaining temperature at 1500° C. for 10 hours, while increasing the temperature at 5° C./min.

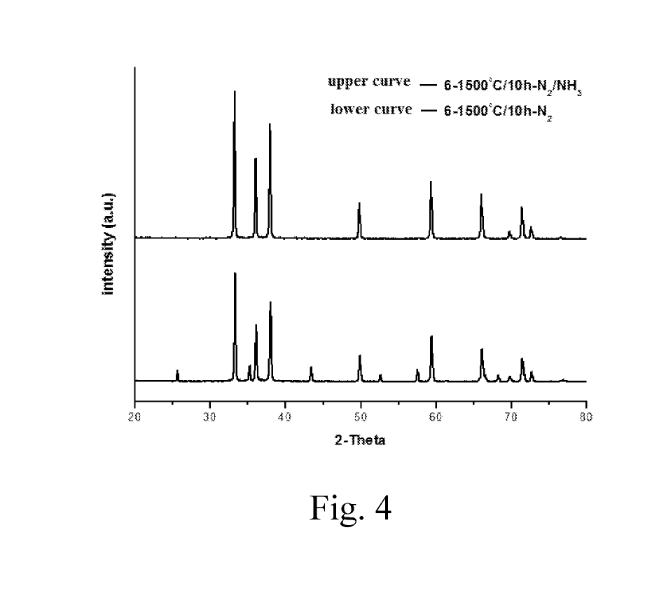

In this process, the atmosphere is formed by pure nitrogen, 50% nitrogen gas and 50% ammonia gas. After carbon-thermal reduction, the powder is placed into an air of 600° C. to perform de-carbonization, while keeping that temperature for 10 hours. The X-ray diffraction patterns of the de-carbonized powder is as shown in FIG. 4. From the diffraction patterns it is evident that, after nitridation in an atmosphere of 50% nitrogen gas and 50% ammonia gas, the powder is of a single pure phase aluminum nitride; while after nitridation in an atmosphere of pure nitrogen gas, the powder is of a α-aluminum nitride (a phase aluminum nitride).

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A method of preparing aluminum nitride powder through atmosphere controlled carbon-thermal reduction, comprising following steps:
(A) providing a γ-aluminum oxide (gamma phase-aluminum oxide);
(B) providing a phenolic resin;
(C) pouring in chemical solution to mix with the γ-aluminum oxide and the phenolic resin, to stir them evenly, and to make phenolic resin dissolve into forming a solution;
(D) putting the solution into a bake oven, to bake and dry it into powder;
(E) placing the powder into a high temperature furnace in a nitridation atmosphere to perform carbonization, to form into powder;
(F) grinding the carbonized powder to particles of diameter less than 2 mm;
(G) adding additive into the grinded powder, to put it into the high temperature furnace of nitridation atmosphere to perform nitridation; and
(H) placing the nitridated powder in air or an oxygen gas atmosphere to perform de-carbonization, to form into aluminum nitride powder.

2. The method of preparing aluminum nitride powder through atmosphere controlled carbon-thermal reduction as claimed in claim 1, wherein grain diameter of the γ-aluminum oxide is 0.08˜2 mm.

3. The method of preparing aluminum nitride powder through atmosphere controlled carbon-thermal reduction as claimed in claim 1, wherein the chemical solution is a water solution containing 40 wt %˜60 wt % of methyl alcohol, ethanol, isoprophyl alcohol, or butyl alcohol.

4. The method of preparing aluminum nitride powder through atmosphere controlled carbon-thermal reduction as claimed in claim 1, wherein weight ratio of the γ-aluminum oxide to the phenolic resin is 1:0.4˜0.8.

5. The method of preparing aluminum nitride powder through atmosphere controlled carbon-thermal reduction as claimed in claim 1, wherein temperature in the high temperature furnace in step (E) is 500° C.˜700° C.

6. The method of preparing aluminum nitride powder through atmosphere controlled carbon-thermal reduction as claimed in claim 1, wherein temperature in the high temperature furnace in step (G) is 1400° C.˜1700° C.

7. The method of preparing aluminum nitride powder through atmosphere controlled carbon-thermal reduction as claimed in claim 1, wherein the additive is urea or azide.

8. The method of preparing aluminum nitride powder through atmosphere controlled carbon-thermal reduction as claimed in claim 1, wherein weight ratio of the ground powder to the additive is 1:0.1˜1.

9. The method of preparing aluminum nitride powder through atmosphere controlled carbon-thermal reduction as claimed in claim 1, wherein in the step (G), the nitridation atmosphere is formed by pure nitrogen gas, mixture of nitrogen gas and hydrogen gas, mixture of nitrogen gas and ammonia gas, or pure ammonia gas.

10. A method of preparing aluminum nitride powder through atmosphere controlled carbon-thermal reduction, comprising following steps:
(A) providing a γ-aluminum oxide (gamma phase-aluminum oxide), particle diameter of the γ-aluminum oxide is 0.08˜2 mm;
(B) providing a phenolic resin;
(C) pouring in chemical solution to mix with the γ-aluminum oxide and the phenolic resin, to stir them evenly, to make phenolic resin dissolve into forming a solution, wherein weight ratio of the γ-aluminum oxide and the phenolic resin is 1:0.4˜0.8, while the chemical solution is a water solution containing 40 wt %˜60 wt % of methyl alcohol, ethanol, isoprophyl alcohol, or butyl alcohol;
(D) putting the solution into a bake oven, to bake and dry it into powder;
(E) placing the powder into a high temperature furnace of temperature 500° C.˜700° C. in a nitridation atmosphere to perform carbonization, to form into powder;
(F) grinding the carbonized powder to particles of diameter less than 2 mm;
(G) adding additive into the ground powder, to put it into the high temperature furnace of nitridation atmosphere at 1400° C.˜1700° C. to perform nitridation, wherein, weight ratio of the ground powder to the additive is 1:0.1˜1, the additive is urea or azide, while the nitridation atmosphere is formed by pure nitrogen gas, mixture of nitrogen gas and hydrogen gas, mixture of nitrogen gas and ammonia gas, or pure ammonia gas; and
(H) placing the nitridated powder in air or an oxygen atmosphere to perform de-carbonization, to form into aluminum nitride powder.
